(19) United States
(12) Patent Application Publication
(10) Pub. No.: US 2021/0268531 A1
(43) Pub. Date: Sep. 2, 2021

(54) Rotatable Positioning Nozzle

(71) Applicant: Ming-Tsan Yen, Changhua City (TW)

(72) Inventor: Ming-Tsan Yen, Changhua City (TW)

(21) Appl. No.: 16/805,942

(22) Filed: Mar. 2, 2020

(51) Int. Cl. B05B 15/652; B05B 1/10

(52) U.S. Cl. CPC B05B 15/652; B05B 1/10

(57) ABSTRACT

A rotatable positioning nozzle contains: a body. The body includes an intake, a spray hole defined opposite to and communicating with the intake, and an engagement groove defined adjacent to the intake. A diameter of the intake decreases, and a cross section of the engagement groove is circular. The engagement groove has an inward shoulder proximate to the intake, an outward shoulder adjacent to the spray hole, multiple limiting recesses surrounding the engagement groove proximate to the inward shoulder, and multiple defining protrusions. A respective one defining protrusion protrudes from two sides of a respective one limiting recess, and the body further includes a second central dotted line defined on a center thereof. The spray hole has a third central dotted line defined on a center thereof, and an angle is defined between the second central dotted line and the third central dotted line.

### BACKGROUND OF THE INVENTION

### Field of the Invention

The present invention relates to a nozzle, and more particularly to a rotatable positioning nozzle which is connected with a water supply source to spray water in a high temperature.

### Description of the Prior Art

A conventional nozzle is connected with a connector, and the connector has multiple balls engaged in an engagement groove, such that the nozzle does not remove from the connector. However, the nozzle can be rotated at an original position, so it cannot be used to spray water at a fixed angle.

The present invention has arisen to mitigate and/or obviate the afore-described disadvantages.

### SUMMARY OF THE INVENTION

The primary objective of the present invention is to provide a rotatable positioning nozzle by which after fixing a body in a receiving orifice of a connector, a respective one of multiple balls of the connector moves into an engagement groove of the body so as to fix the body in the receiving orifice, the respective one ball moves into a respective one of multiple limiting recess to limit rotation of the body, thus avoiding spraying water in an unexpected direction. Preferably, a spray hole of the body is adjusted in a desired direction, and the body is pressed to urge the respective one ball to remove from the respective one limiting recess, thus avoiding unexpected the rotation of the body because of accidental collision or water pressure.

To achieve above-mentioned objectives, a rotatable positioning nozzle provided by the present invention contains: a body. The body includes an intake defined on a first end thereof, a spray hole formed on a second end of the body and communicating with the intake, an engagement groove defined on an outer wall of the body adjacent to the intake. A diameter of the intake decreases, a cross section of the engagement groove is circular, the engagement groove has an inward shoulder proximate to the intake, an outward shoulder adjacent to the spray hole, multiple limiting recesses surrounding the engagement groove proximate to the inward shoulder, and multiple defining protrusions. A respective one defining protrusion protrudes from two sides of a respective one limiting recess, the body further includes a first central dotted line defined on a center thereof, the spray hole has a second central dotted line defined on a center thereof, and an angle is defined between the second central dotted line and the first central dotted line.

### BRIEF DESCRIPTION OF THE DRAWINGS

FIG. 1 is a perspective view showing the assembly of a rotatable positioning nozzle according to a preferred embodiment of the present invention.

FIG. 2 is a perspective view showing the exploded components of the rotatable positioning nozzle according to the preferred embodiment of the present invention.

FIG. 3 is another perspective view showing the exploded components of the rotatable positioning nozzle according to the preferred embodiment of the present invention.

FIG. 4 is a cross sectional view showing the exploded components of the rotatable positioning nozzle according to the preferred embodiment of the present invention.

FIG. 5 is a cross sectional view showing the operation of the rotatable positioning nozzle according to the preferred embodiment of the present invention.

FIG. 6 is another cross sectional view showing the operation of the rotatable positioning nozzle according to the preferred embodiment of the present invention.

FIG. 7 is also another cross sectional view showing the operation of the rotatable positioning nozzle according to the preferred embodiment of the present invention.

FIG. 8 is still another cross sectional view showing the operation of the rotatable positioning nozzle according to the preferred embodiment of the present invention.

FIG. 9 is another cross sectional view showing the operation of the rotatable positioning nozzle according to the preferred embodiment of the present invention.

FIG. 10 is a perspective view showing the operation of the rotatable positioning nozzle according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

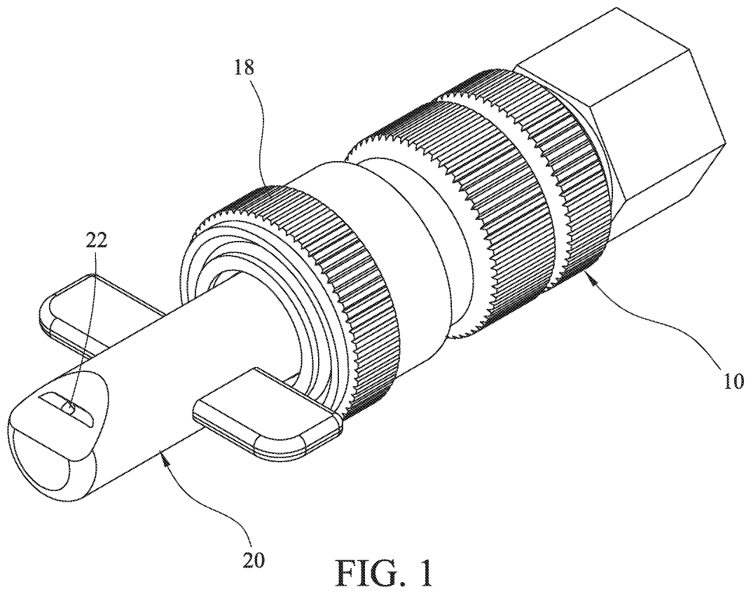

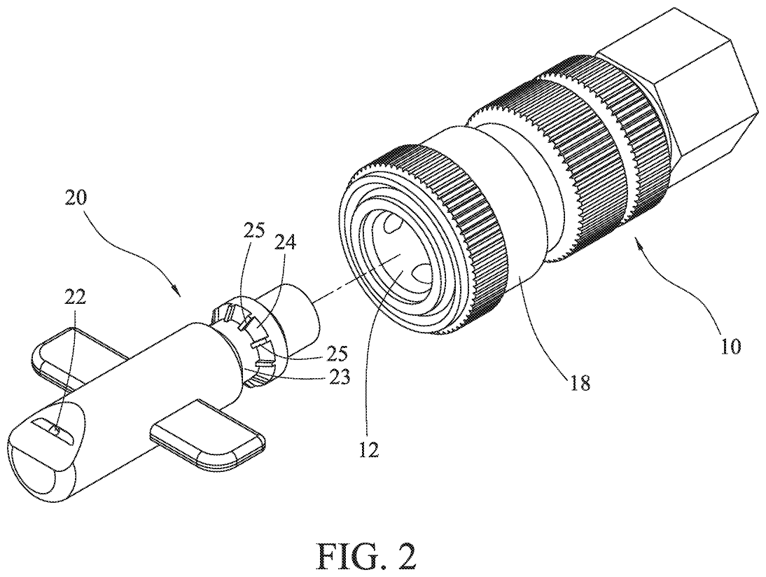

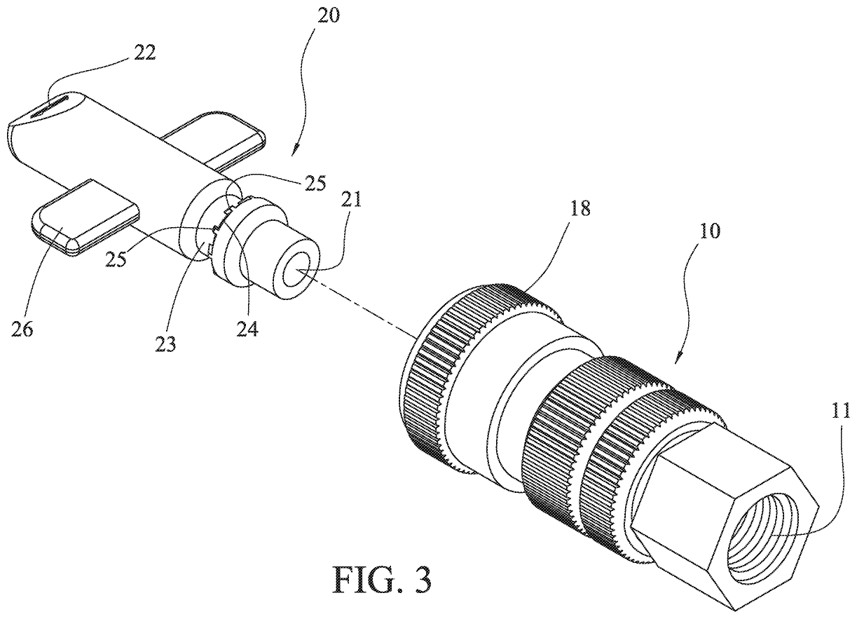

With reference to FIGS. 1-4, a rotatable positioning nozzle according to a preferred embodiment of the present invention comprises: a connector 10 and a body 20.

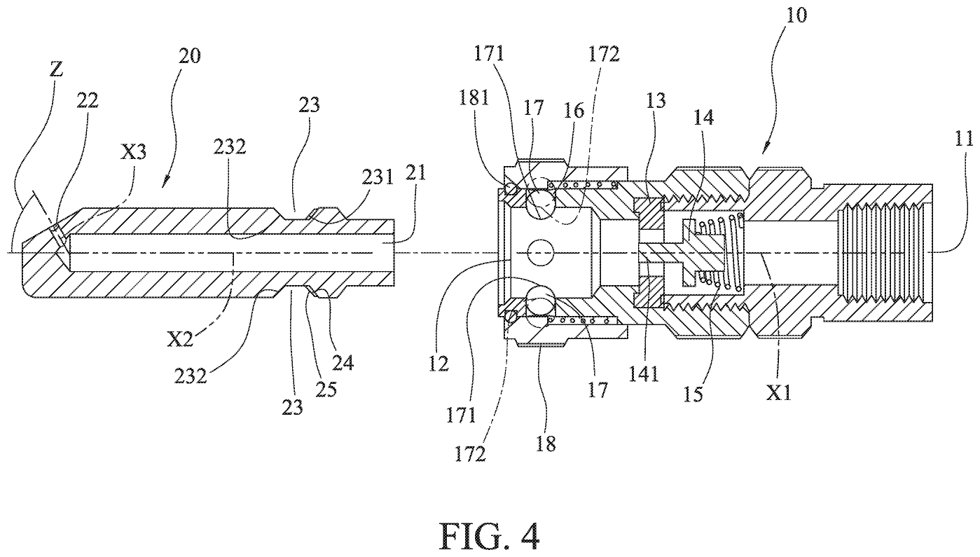

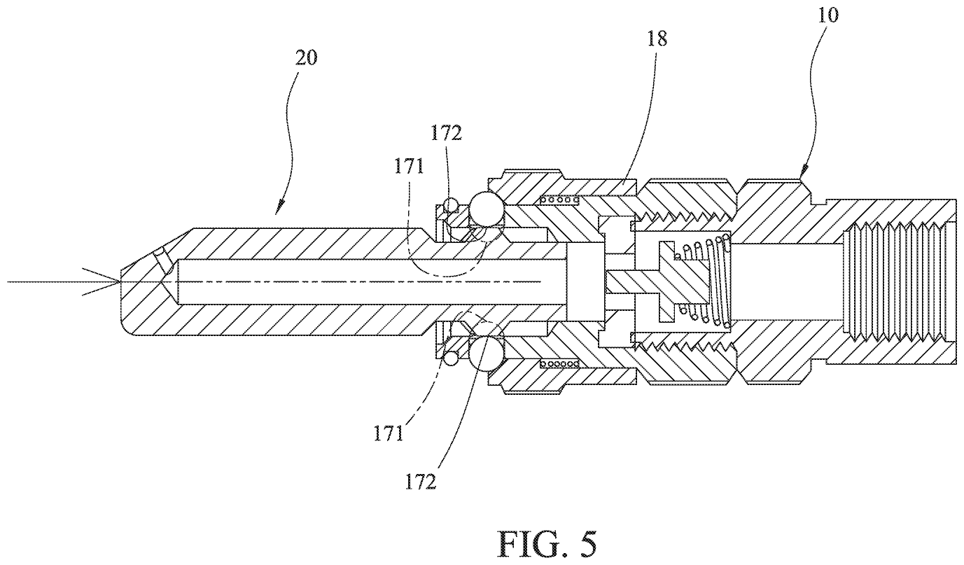

The connector 10 includes an inlet segment 11 formed on a first end thereof and configured to receive water, a receiving orifice 12 defined on a second end of the connector 10 opposite to and communicating with the inlet segment 11, a seal ring 13 defined between and configured to or not to communicate the inlet segment 11 with the receiving orifice 12, a fluid valve 14, and a push spring 15. The seal ring 13 is accommodated in the connector 10, when the push spring 15 pushes the fluid valve 14 to abut against the seal ring 13, the inlet segment 11 does not communicate with the receiving orifice 12. When the fluid valve 14 is urged to move away from the seal ring 13, the inlet segment 11 communicates with the receiving orifice 12. The fluid valve 14 has an actuation post 141 extending to the receiving orifice 12, and the connector 10 further includes multiple apertures 16 defined adjacent to the receiving orifice 12 and configured to accommodate the multiple balls 17 respectively, a control sleeve 18 arranged around an outer wall of the connector 10, a drive spring 19, and a locking ring 181 configured to control a respective one ball 17 to move toward a respective one of multiple first positions 171 or a respective one of multiple second positions 172 (as shown in FIGS. 4 and 5). The drive spring 19 pushes the control sleeve 18 to move to the receiving orifice 12, the locking ring 181 is configured to limit the control sleeve 18, and the receiving orifice 12 has a first central dotted line X1 defined along a center thereof, the multiple first positions 171 are close to the first central dotted line X1, and the multiple second positions 172 are away from the first central dotted line X1.

The body 20 includes an intake 21 defined on a first end thereof, a spray hole 22 formed on a second end of the body 20 and communicating with the intake 21, an engagement groove 23 defined on an outer wall of the body 20 adjacent to the intake 21, wherein a diameter of the intake 21 decreases, and a cross section of the engagement groove 23 is circular. The engagement groove 23 has an inward tilted shoulder 231 proximate to the intake 21, an outward tilted shoulder 232 adjacent to the spray hole 22, multiple limiting recesses 24 surrounding the engagement groove 23 proximate to the inward tilted shoulder 231, and multiple defining protrusions 25, wherein a respective one defining protrusion 25 protrudes from two sides of a respective one limiting recess 24. When a respective one ball 17 moves on the respective one first position 171, it moves into the engagement groove 23. When a respective one ball 17 moves on the respective one second position 172, it removes from the engagement groove 23. The body 20 further includes a second central dotted line X2 defined on a center thereof, and the spray hole 22 has a third central dotted line X3 defined on a center thereof, wherein an angle Z between the third central dotted line X3 and the second central dotted line X2 is 10 degrees to 45 degrees.

The body 20 further includes an operation portion 26 arranged adjacent to the spray hole 22 and extending from two sides of the outer wall of the body 10 to form a sheet shape, so as to press and rotate the body 20.

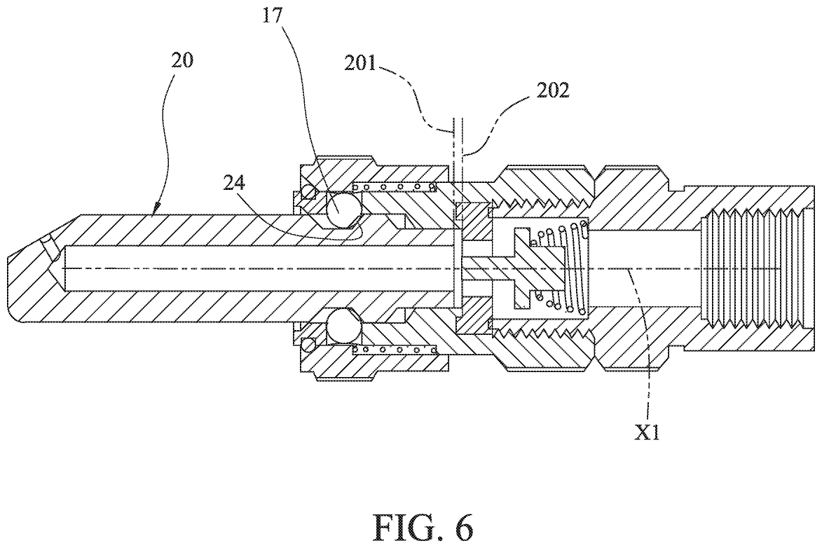

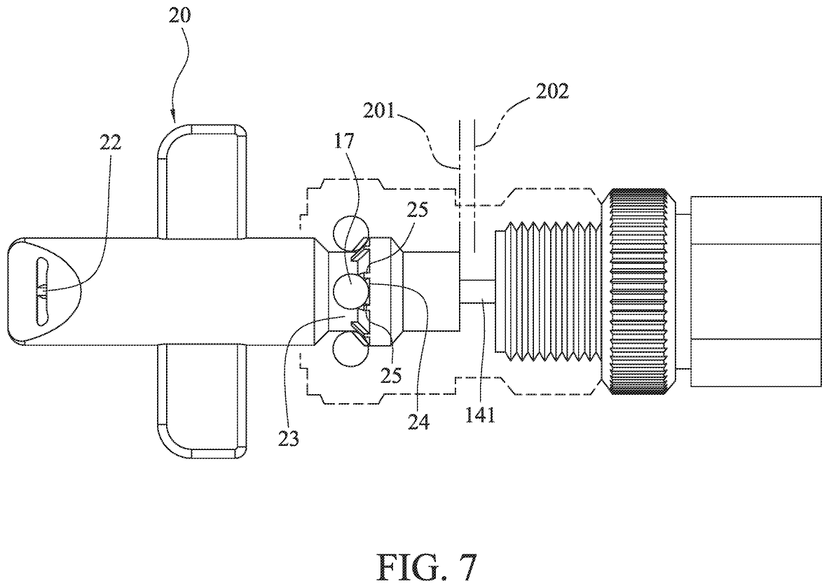

The first end of the body 20 is inserted into the receiving orifice 12 to push the actuation post 141, such that the fluid valve 14 is urged by the actuation post 141 to open and drive the push spring 15, hence the inlet segment 11 communicates with the receiving orifice 12. When the respective one ball 17 moves to the respective one first position 171 from the respective one second position 172 to enter the engagement groove 23 (as shown in FIG. 6), the body 20 moves to a third position 201 or a fourth position 202, wherein when the body 20 is not pressed, it is located on the third position 201, and when the body 20 is pressed, it is located on the fourth position 202, hence the respective one ball 17 is maintained on the respective one first position 171, as illustrated in FIG. 7.

In operation, the inlet segment 11 of the connector 10 is connected with a water supply source, and the control sleeve 18 is pushed as shown in FIG. 5, such that the inlet segment 21 of the body 20 is inserted into the receiving orifice 12, the respective one ball 17 moves to the respective one second position 172 from the respective one first position 171, and the control sleeve 18 is released so that the respective one ball 17 moves to the respective first position 171 from the respective one second position 172, and the respective one ball 17 move into the engagement groove 23, the inlet segment 21 of the body 20 pushes the actuation post 141 to open the fluid valve 14, wherein the fluid valve 14 and the body 20 are pushed by the push spring 15 to move into to the receiving orifice 12. In the meantime, the body 20 is located on the third position 201, and the respective one ball 17 is moved into the respective one limiting recess 24 so that two sides of the respective ball 17 are fixed by the respective one defining protrusion 25, as shown in FIGS. 6 and 7, the first central dotted line X1 overlaps with the second central dotted line X2, such that when supplying the water to the rotatable positioning nozzle, the body 20 sprays the water in a spraying angle.

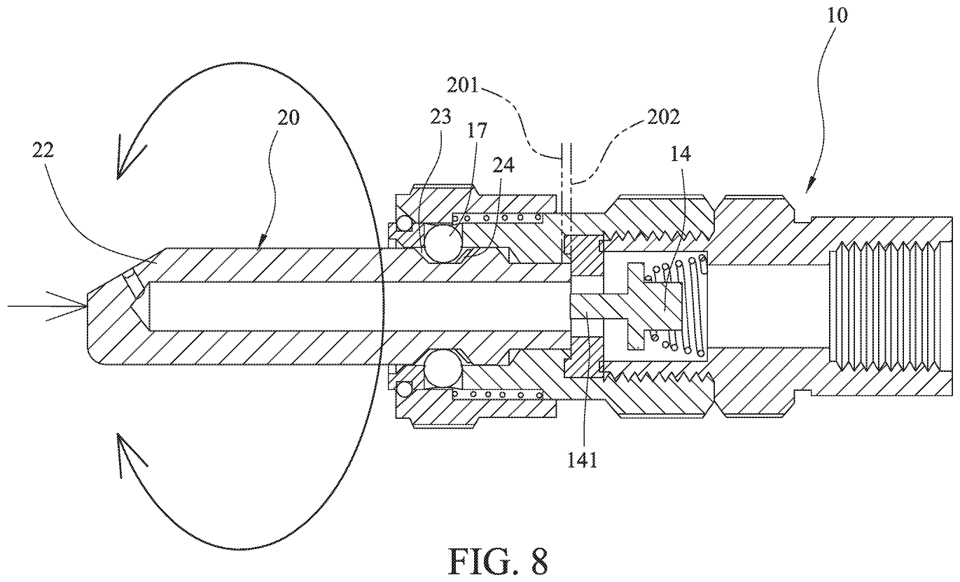

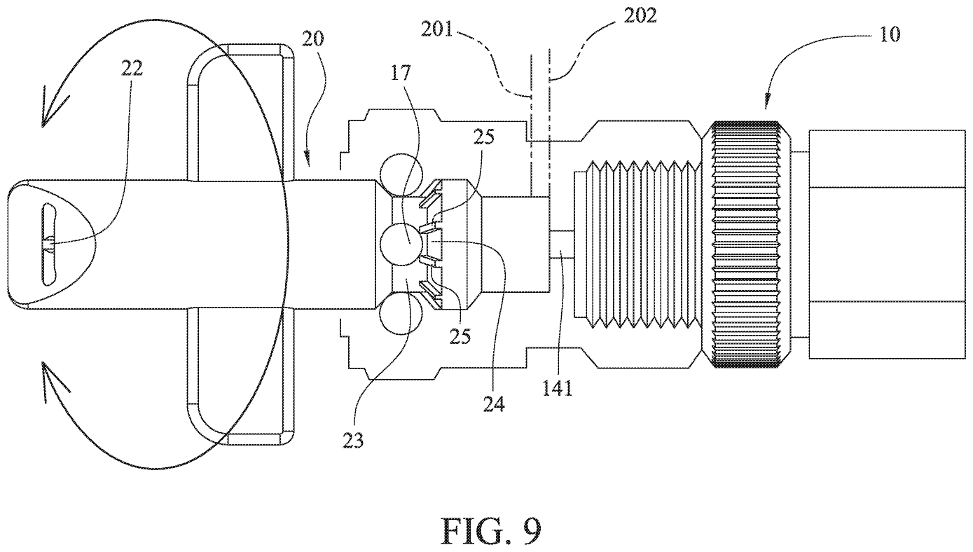

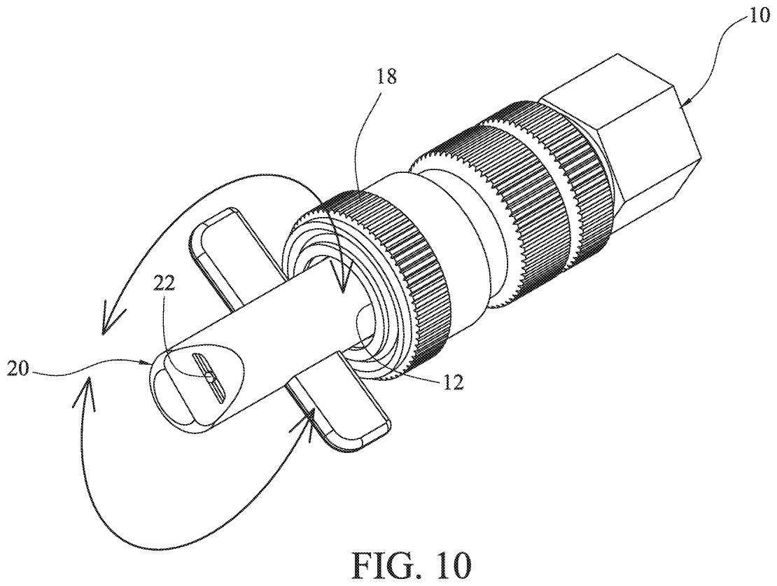

As desiring to change the spraying angle of the body 20, as illustrated in FIGS. 8-10, the body 20 is pressed to move to the fourth position 202 from the third position 201, the respective one ball 17 is fixed in the engagement groove 23 on the respective first position 171, and the two sides of the respective one ball 17 are not fixed by the respective one defining protrusion 25 so that the body 20 is manually rotated to any desired angles along the first central dotted line X1, as illustrated in FIG. 10. After stopping pressing the body 20, the fluid valve 14 and the push spring 15 push the body 20 back to the third position 201 so that the respective one ball 17 moves into the respective one limiting recess 24 at the desired angle, thus limiting rotation of the body 20 again.

After fixing the body 20 in the receiving orifice 12 of the connector 10, the respective one ball 17 of the connector 10 moves into the engagement groove 23 of the body 20 so as to fix the body 20 in the receiving orifice 12, the respective one ball 17 moves into the respective one limiting recess 24 to limit the rotation of the body 20, thus avoiding spraying the water in an unexpected direction. Preferably, the spray hole 22 of the body 20 is adjusted in a desired direction, and the body 20 is pressed to urge the respective one ball 17 to remove from the respective one limiting recess 24, thus avoiding unexpected rotation of the body 20 because of accidental collision or water pressure.

While various embodiments in accordance with the present invention have been shown and described, it is clear to those skilled in the art that further embodiments may be made without departing from the scope of the present invention.

What is claimed is:

1. A rotatable positioning nozzle comprising:
a body including an intake defined on a first end of the body, a spray hole formed on a second end of the body and communicating with the intake, an engagement groove defined on an outer wall of the body adjacent to the intake, wherein a diameter of the intake decreases, a cross section of the engagement groove is circular, the engagement groove has an inward shoulder proximate to the intake, an outward shoulder adjacent to the spray hole, multiple limiting recesses surrounding the engagement groove proximate to the inward shoulder, and multiple defining protrusions, wherein a respective one defining protrusion protrudes from two sides of a respective one limiting recess, wherein the body further includes a second central dotted line defined on a center thereof, and the spray hole has a third central dotted line defined on a center thereof, wherein an angle is defined between the second central dotted line and the third central dotted line.

2. The rotatable positioning nozzle as claimed in claim 1 further comprising a connector including an inlet segment formed on a first end of the connector and configured to receive water, a receiving orifice defined on a second end of the connector opposite to and communicating with the inlet segment, a seal ring defined between and configured to or not to communicate the inlet segment with the receiving orifice, a fluid valve, and a push spring; wherein the seal ring is accommodated in the connector; when the push spring pushes the fluid valve to abut against the seal ring, the inlet segment does not communicate with the receiving orifice; when the fluid valve is urged to move away from the seal ring, the inlet segment communicates with the receiving orifice, the fluid valve has an actuation post extending to the receiving orifice, and the connector further includes multiple apertures defined adjacent to the receiving orifice and configured to accommodate the multiple balls respectively, a control sleeve arranged around an outer wall of the connector, a drive spring, and a locking ring configured to control a respective one ball to move toward a respective one of multiple first positions or a respective one of multiple second positions, wherein the drive spring pushes the control sleeve to move to the receiving orifice, the locking ring is configured to limit the control sleeve, and the receiving orifice has a first central dotted line defined along a center thereof, wherein the first end of the body is inserted into the receiving orifice to push the actuation post, such that the fluid valve is urged by the actuation post to open and drive the push spring, hence the inlet segment communicates with the receiving orifice; when the respective one ball moves to the respective one first position from the respective one second position to enter the engagement groove, the body moves to a third position or a fourth position.

3. The rotatable positioning nozzle as claimed in claim 1, wherein the inward shoulder is tilted, and the outward shoulder is tilted.

4. The rotatable positioning nozzle as claimed in claim 1, wherein the angle between the second central dotted line and the third central dotted line is 10 degrees to 45 degrees.

5. The rotatable positioning nozzle as claimed in claim 1, wherein the body further includes an operation portion arranged adjacent to the spray hole.

6. The rotatable positioning nozzle as claimed in claim 5, wherein the operation portion extends from two sides of the outer wall of the body so as to form a sheet shape.
